(19) United States
(12) Patent Application Publication
(10) Pub. No.: US 2024/0300262 A1
(43) Pub. Date: Sep. 12, 2024

(54) VEHICLE WHEEL RIM

(71) Applicant: Raphael Schlanger, Wilton, CT (US)

(72) Inventor: Raphael Schlanger, Wilton, CT (US)

(21) Appl. No.: 18/599,638

(22) Filed: Mar. 8, 2024

Related U.S. Application Data
(60) Provisional application No. 63/451,604, filed on Mar. 12, 2023.

(51) Int. Cl. B60B 1/04; B60B 21/06

(52) U.S. Cl. CPC B60B 1/044; B60B 21/062; B60B 2320/10

(57) ABSTRACT

A rim for a vehicle wheel, including: an axial axis; a radial axis; a spoke bed wall having an outboard surface, an inboard surface, and a radial thickness; a spoke hole to receive a spoke having an outboard opening and a spoke hole axis. At least one of the inboard surface and outboard surface is radially variable to provide a first radial thickness region laterally surrounding said spoke hole and a second radial thickness region of reduced radial thickness relative to the first radial thickness region. The outboard surface includes a radially inwardly recessed surface within the first radial thickness region. At least a portion of the recessed surface is configured to provide a bearing surface for engagement with the spoke and to support of spoke tension forces.

### BACKGROUND OF THE INVENTION

### (1) Field of the Invention

The present invention relates to spoked vehicle wheels and bicycle wheels in particular. More specifically, this invention relates to the spoke bed of a vehicle wheel rim where the spoke bed is contoured to optimize its strength and to optimize the connection with a spoke connected thereto.

### (2) Description of the Related Art

In the development of a tension-spoked wheel, the geometry of interaction between the spoke and the rim is of particular importance as it relates to the strength, stiffness, and longevity of the completed wheel structure. The overlie engagement between the under-head surface of the spoke nipple and the spoke bed of the rim serves to provide the requisite bracing to resist the spoke tension forces of the wheel.

The spoke commonly has a bracing angle with the rim. In wheels with “crossed” or tangential lacing, the spoke commonly has a circumferential angle with the rim. This is particularly understood and is evident on the conventional spoked bicycle wheel. Firstly, it is shown that, due to the bracing and/or circumferential angles of the spoke, the under-head surface of a conventional spoke nipple commonly contacts and braces against the rim's spoke bed at only a single contact point. This is explained in greater detail in U.S. Pat. No. 7,427,112 discussions of prior art. This singular contact point results in a very small area of contact such that the high spoke tension of modern wheels, creates very high contact stress at this contact point. The result is excessive galling between the spoke nipple and the rim as the nipple is rotatably adjusted to bring the spoke up to the desired tension. This creates resistance to rotation of the nipple and thereby makes the nipple more difficult to adjust. In addition, this also causes the nipple and rim to abrade against each other, removing nipple and/or rim material and potentially weakening the structural integrity of one or both of these components.

Further, it is well understood that the spoke hole of the rim constitutes a structural stress riser in the rim. Accordingly, it may be viewed that the spoke hole effectively causes a localized weakness to the rim. With conventional spoke nipples, the bearing interface between the nipple and the rim occurs directly at the edge of the spoke hole, commonly the weakest point of the rim's spoke bed. It is also understood that, in use, the wheel is subject to both static loads (due to spoke pre-tension) and cyclic loads (due to rolling of the wheel under load). The combination of rim weakness and high contact stresses at this interface results in cracks in the spoke bed due to fatigue loading. These cracks commonly radiate outwardly from the spoke hole. This requires that rims be heavily reinforced and thickened in the spoke bed region of the rim, which adds weight to the rim and to the assembled wheel. Since rims are commonly produced in an extrusion process, selective thickening is not feasible and this thickened spoke bed extends around the full circumference of the rim, not just in the regions surrounding the spoke holes. As such, this further increases additional weight of prior-art rims.

Secondly, this single contact point is laterally offset from the centerline of the spoke. Since the spoke tension acts along the spoke's centerline, and the resisting force acts at the singular contact point, this offset creates a bending moment at the spoke nipple. Since the spoke tension increases and decreases cyclically as the wheel is rotated, this bending moment introduces a cyclic bending stress to the spoke, which reduces the fatigue life of the spoke, the nipple, and/or rim. In fact, it is not at all uncommon for a spoke to fail due to cyclic fatigue under normal use.

Further, this bending moment tends to deflect the spoke and add a bent region in the spoke adjacent the nipple. The bent region will tend to flex somewhat due to the variations in spoke tension experienced during normal use of the wheel. This flex has the effect of reducing the effective tensile stiffness of the spoke and thus tends to reduce the lateral stiffness of the wheel. The result is a wheel that is “flexier” and more easily deflected, lending a less responsive feel on the part of the rider. This bending also serves to increase fatigue stresses and exacerbate spoke failure due to fatigue.

### SUMMARY OF THE INVENTION

The present invention includes a rim having a thickened spoke bed region surrounding the spoke hole and the connection with the spoke. The thickened region provides additional strength and stiffness in this most highly stressed region of the rim.

The present invention further includes a bearing surface that is longitudinally inwardly recessed from the outboard surface of the spoke bed. This recessed bearing surface preferably provides an optimized bearing interface with the spoke to increase the contact area of interface and thereby reduce stress in both the spoke and the rim. Since the spoke bed is thickened in this region, any reduction in spoke bed thickness associated with the recessed bearing surface is compensated by this additional thickness of the thickened region.

In comparison with conventional spoke/rim connections, this optimized bearing surface serves to provide (i) a greater area of bearing interface, thus reducing the corresponding bearing stresses; and/or (ii) alignment of this bearing interface with the spoke to minimized any bending moment to further reduce stresses and bending or flex of the spoke.

In accordance with the present invention, it has now been found that the forgoing objects and advantages may be readily obtained.

Since the rim may be thinned in the low-stress regions between the adjacent spoke connections, the overall weight of the rim may be reduced. Lighter weight serves to increase the performance of the rim and minimize raw material used for potential manufacturing cost savings.

Since the area of bearing interface is increased, the associated stresses in the spoke and/or rim are reduced. This serves to reduce any galling or resistance to threadable adjustment of the spoke nipple. This also serves to reduce the aforementioned lateral offset and associated bending moment to further reduce stresses and bending or flex of the spoke.

The thickened regions surrounding the spoke holes may provide additional strength and stiffness to support spoke tension forces.

The advantages of the present invention provide several benefits over existing wheel designs, including: an increase in the fatigue life of the wheel; a reduction in the weight of the wheel; an increase in the lateral stiffness of the wheel; reduction or elimination of the galling and abrasion between the spoke and the nipple; the ability to produce the wheel economically at low cost; and an increase in strength of the rim.

The novel features, which are believed to be characteristic of the invention, both as to organization and method of operation, together with further objects and advantages thereof, will be better understood from the following description of the accompanying drawings of the embodiments of the present invention. It is expressly understood, however, that the drawings are for the purpose of illustration and description only and are not intended as a definition of the limits of the invention.

Further features of the present invention will become apparent from considering the drawings and ensuing description.

### BRIEF DESCRIPTION OF THE DRAWINGS

The present invention will be more readily understandable from a consideration of the accompanying exemplificative drawings, wherein:

FIG. 1 is a perspective view schematically illustrating the general configuration of a prior art vehicle wheel as applied to a bicycle wheel;

FIG. 2a is an axial plan view illustrating a prior art bicycle wheel;

FIG. 2b is a cross-section view of the prior art bicycle wheel as seen generally in the direction 15-15 of FIG. 2a;

FIG. 2c is a fragmentary view, detailing the view illustrated in FIG. 2b, where the hub flange is shown in a partial cross-section to illustrate the connection with the spoke;

FIG. 3a is a fragmentary perspective exploded view of a wheel of prior art design, with the rim shown in axial plane cross-section;

FIG. 3b is an enlarged perspective detail of a portion of the rim of FIG. 3a, with the rim shown in axial plane cross-section;

FIG. 3c is a fragmentary perspective view, with the rim in cross-section, showing the wheel of FIG. 3a with the spoke and nipple assembled to the rim;

FIG. 3d is a axial plane cross-section detail view of the wheel of FIG. 3c;

FIG. 3e is a cross-section detail view along 57 of FIG. 3d;

FIG. 3f is a cross-section detail view of the wheel of FIG. 3d, showing a bent region of the spoke;

FIG. 4a is a fragmentary perspective view of a wheel of prior art design, with the rim shown in axial plane cross-section;

FIG. 4b is an axial-plane cross-section detail view of the wheel of FIG. 4a, taken along 71-71;

FIG. 4c is a radial-plane cross-section detail view of the wheel of FIG. 4a, taken along 71-71;

FIGS. 5a-c are fragmentary axial-plane cross-section detail views of a wheel of prior art design, describing the sequential steps involved assembling an internal nipple and spoke to a rim;

FIG. 5a shows the internal spoke nipple prior to its threadable assembly to the spoke;

FIG. 5b shows the internal spoke nipple next threadably assembled to the spoke, with the bearing surface initially contacting the spoke bed of the rim;

FIG. 5c shows the internal spoke nipple next threadably tightened to the spoke, with the engagement face fully contacting the spoke bed of the rim, causing the spoke to flex and bend;

FIGS. 6a-f show a first embodiment of the present invention, showing the inboard surface of the rim as variable to provide a thickened region of the spoke bed and describing the sequential steps involved in creating a skewed bearing surface in the spoke bed;

FIG. 6a is an axial-plane cross section detail view, showing a step drill and a rim prior to its being drilled for both the spoke hole and the spoke access hole by the step drill;

FIG. 6b is an axial-plane cross section detail view of the embodiment of FIG. 6a, showing the rim as first drilled to include the spoke hole and spoke access hole by the step drill, and showing a rotary facing tool prior to its being used to create a skewed bearing surface in the spoke bed;

FIG. 6c is an axial-plane cross section detail view showing the rim of FIG. 6b as next faced by the rotary facing tool to create a skewed bearing surface in the spoke bed of flat contour, particularly illustrating the axial skew angle of the bearing surface;

FIG. 6d is an axial-plane cross section detail view showing the rim of FIG. 6c as next assembled with a spoke and spoke nipple;

FIG. 6e is a radial-plane cross section detail view showing the rim of FIG. 6d, particularly illustrating the circumferential skew of the bearing surface;

FIG. 6f is a cross section detail view of a second embodiment of the present invention, showing the rim in axial-plane cross-section and corresponding to the view of FIG. 6d, including the substitution of an internal nipple and corresponding rim for the nipple and rim of FIG. 6d;

FIG. 6g is a cross section detail view of a third embodiment of the present invention, showing the rim in axial-plane cross-section and corresponding to the view of FIG. 6d, including a skewed bearing surface with a concave conical contour;

FIG. 6h is a cross section detail view of a fourth embodiment of the present invention, showing the rim in axial-plane cross-section and corresponding to the view of FIG. 6d, including a skewed bearing surface with a concave spherical contour;

FIG. 7a is a cross section detail view of a fifth embodiment of the present invention, showing the rim in axial-plane cross-section and corresponding to the view of FIG. 6d, and showing the outboard surface as variable to provide a thickened region of the spoke bed, including a spoke and spoke nipple assembled thereto;

FIG. 7b is a radial-plane cross section detail view of the embodiment of FIG. 7a, particularly illustrating the circumferential skew angle of the bearing surfaces;

FIGS. 8a-c describe a sixth embodiment of the present invention, showing the inboard surface of a rim as variable to provide a thickened region of the spoke bed, and showing a rim and describing the sequential steps involved in deforming the rim to create a skewed bearing surface in the spoke bed;

FIG. 8a is a partial axial-plane cross section detail view of the rim, showing a punch prior to the rim being deformed to form bearing surface;

FIG. 8b is a partial axial-plane cross section detail view of the embodiment of FIG. 8a, showing the punch as next pressed into the outboard surface to deform the outboard surface and create a skewed bearing surface in the spoke bed;

FIG. 8c is an axial-plane cross section detail view showing the rim of FIG. 8b showing the punch as next removed and showing the bearing surface debossed onto the outboard surface.

### DETAILED DESCRIPTION OF THE INVENTION

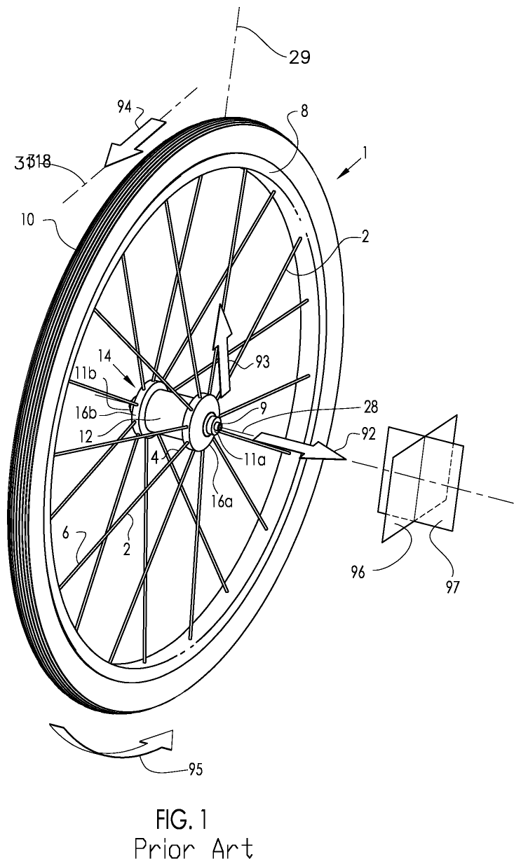

FIG. 1 describes the basic schematic configuration of an exemplary prior art vehicle wheel, in particular, a bicycle wheel 1, as well as a description of the direction conventions used throughout this disclosure. For clarity, the bicycle frame and the quick release skewer assembly are not shown in this figure. The hub shell 14 is rotatable about the axle 9 and includes at least two axially spaced hub flanges 16a and 16b, each of which include a means for connecting with a multiplicity of spokes 2 connected thereto. Axle 9 includes end faces 11a and 11b that define the spacing of its mounting with the frame (not shown). The axial axis 28 is the axial centerline of rotation of the bicycle wheel 1. The hub flanges 16a and 16b may be contiguous with the hub shell 14 or may be separately formed and assembled to the hub body 12 portion of the hub shell 14. Each spoke 2 is affixed to its respective hub flange 16a or 16b at its first end 4 and extend to attach the rim 8 at its second ends 6. The tire 10 is fitted to the outer periphery of the rim 8. The wheel of FIG. 1 is generic and may be of tension-spoke or compression-spoke design.

The axial direction 92 is any direction parallel with the axial axis 28. The radial direction 93 is a direction generally perpendicular to the axial direction 92 and extending generally from the axial axis 28 radially outwardly toward the rim 8. The tangential direction 94 is a direction generally tangent to the rim at a given radius. The circumferential direction 95 is a cylindrical vector that wraps around the axial axis 28 at a given radius. A radial plane 96 is a plane perpendicular to the axial axis 28 that extends in a generally radial direction at a given axial intercept. An axial plane 97 is a plane that extends along the axial axis 28. An orientation that is radially inboard (or inward) is nearer to the axial axis 28 of rotation and a radially outboard (or outward) is further from the axial axis 28. An axially inboard (or inward) orientation is an orientation that is axially proximal to the axial midpoint between the two end faces 11a and 11b. Conversely, an axially outboard (or outward) orientation is an orientation that is axially distal to the axial midpoint between the two end faces 11a and 11b. A radially inboard orientation is an orientation that is radially proximal to the axial axis 28 and a radially outboard orientation is an orientation that is radially distal to the axial axis 28. An axially inwardly facing surface is a surface that faces toward the axial midpoint between the two end faces 11a and 11b. Conversely, an axially outwardly facing surface is a surface that faces away from the axial midpoint between the two end faces 11a and 11b.

The axial axis 28 is the central axis of rotation of the wheel. A radial axis 29 is an axis extending perpendicular to and intersecting with the axial axis 28. A tangential axis 31 is an axis in the radial plane 96 that is perpendicular to the radial axis 29 and radially offset from the axial axis 28.

While it is most common for the hub shell 14 to rotate about a fixed axle 9, there are some cases where it is desirable to permit the axle 9 to be fixed with the wheel 1 such as the case where the wheel 1 is driven by the axle 9.

For the purposes of using conventional terminology, the term “hub flange” is used herein to describe a region of the hub shell 14 to which the spokes 2 are joined. While the surface of the hub flange may be raised and flange-like in comparison to other surfaces of the hub shell 14, this is not a requirement for the present invention and the hub flange 16 may alternatively be flush or recessed relative to other hub shell surfaces.

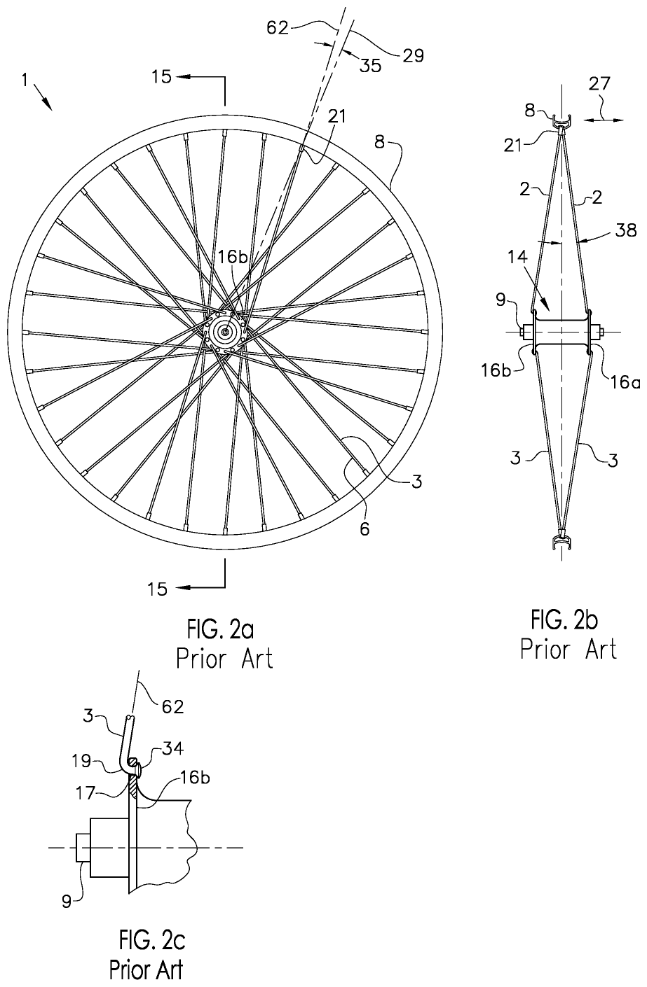

As is well known in the art, a wheel 1 may be of tension-spoke construction, where the central hub hangs in tension by the spokes from the rim portion directly above, or it may be of compression-spoke construction, where the hub is supported by compressing the spoke directly beneath it. Since the present invention may be directed toward bicycle wheels and since the tension-spoke wheel is generally a more efficient structure than compression-spoke wheel, most of the discussion herein is focused with an eye toward tension-spoke wheel construction. However, it is anticipated that most, if not all, of the embodiments of the present invention may be adapted or otherwise applied to compression-spoke wheel construction as well. For a tension-spoke wheel, it is preferable that the wheel includes at least two hub flanges that are axially spaced on either side of the rim or, more specifically, the spoke attachment points at the rim. Thus, the spokes fixed to opposite hub flanges will converge as they extend to the rim as illustrated in FIG. 2b. Additionally, a tension-spoke wheel will usually be pre-tensioned during assembly to create a pre-tensioned structure of balanced spoke tension that allows the axle supporting loads to be distributed among several, if not all, of the spokes of the wheel. It is this ability to share the stresses among its spokes that helps to make the tension-spoke wheel the highly efficient structure that it is. For a compression-spoke wheel, it is often preferable to employ at least two axially spaced hub flanges, however, in the case where the spokes have sufficient bending stiffness to support the requisite lateral or side-to-side loads, only a single hub flange may be employed.

The spoke 2 is a generally long slender tensile element with a longitudinal axis 62 along its length and generally parallel to its sidewalls. The spoke 2 also has a tensile axis 61 of applied tensile load 58 that extends along the span portion of the spoke 2 between its anchor points at the rim 8 and hub flange 16. The tensile axis 61 is generally collinear to the longitudinal axis 62, except where the spoke 2 is bent to deviate from the tensile axis 61. For the purposes of definition, as relating to spokes 2 and connections thereto, the term “longitudinal” herein refers to alignment along the longitudinal axis 62. A longitudinally inboard (or inward) orientation refers to an orientation proximal the midpoint of the span portion. Conversely, a longitudinally outboard (or outward) orientation refers to an orientation distal the midpoint of the span portion. The term “lateral” herein refers to an orientation in a direction generally perpendicular to the longitudinal axis 62. A laterally inboard (or inward) orientation refers to an orientation proximal the longitudinal axis. Conversely, a laterally outboard (or outward) orientation refers to an orientation distal the longitudinal axis 62.

FIGS. 2a, 2b and 2c describe the current technology in conventional bicycle wheels that most cyclists are familiar with. This prior art design includes a rim 8, a hub shell 14 and a plurality of spokes 3. The hub shell 14 is rotatable about the axle 9 and includes a pair of axially spaced hub flanges 16a and 16b. The wheel is assembled by first threading each individual spoke 3 through an axial hole 17 in the hub flange 16 until the j-bend 19 of the first end 4 is hooked within the hole 17. The spoke 3 is then pivoted to extend in a generally radial direction toward the rim 8. The enlarged portion 34 or “head” of the spoke 3 prevents the spoke 3 from pulling through the hole 17 in the hub flange 16a. The second end 6 of each spoke 3 is then fixed to the rim 8 via spoke nipples 21. The span of the spoke 3 is defined herein as the portion of the spoke 3 that spans between its connection to the hub flange (16a or 16b) at its first end 4 and its connection to the rim 8 at its second end 6 and the span length refers to the longitudinal length of the span. Tightening the threaded engagement between the spoke nipple 21 and the spoke 3 serves to effectively shorten the span length of the spoke 3. Thus, as the nipples 21 are threadably tightened, the spokes 3 are drawn up tight and a degree of pre-tension is induced in each spoke 3. By selectively adjusting this threaded engagement, the spoke pre-tension may be adjusted and balanced relative to the other spokes 3 and to also align the trueness and roundness of the rim 8. The spoke pre-tension is resisted by circumferential compression of the rim 8 and it is this balance of forces that imparts efficient structural integrity to the bicycle wheel 1. Also shown in FIG. 2b, there is lateral bracing angle 38 between the radial centerline plane of the rim 8 and the centerline 62 of the spoke 3. As this bracing angle 38 is increased, the lateral or side-to-side stiffness (i.e. stiffness in the axial direction 92) of the wheel 1 is also increased. As shown in FIG. 2a, the spokes are shown with common “crossed” lacing where the spokes 2 span to be tangent to their corresponding hub flanges 16a and 16b. As such, there is a circumferential angle 35 between the longitudinal axis 62 and the radial axis 29.

It is noted that the threadable connection between the nipple 21 and its mating spoke 3 serves both as a pre-tensioning means and as a means to lock the second end 6 of the spoke 3 to the rim 8 during use of the bicycle wheel. This pre-tensioning means occurs within the spoke itself since the engagement interface (i.e. the threadable engagement) serves to both induce the pre-tension in the spoke and to maintain this pre-tension during operation of the wheel 1. This requires that this threadable connection be robust enough to perform both of these functions and that the threadable engagement must operate smoothly and consistently. As such, both the spoke 3 and the nipple 21 are preferably metallic materials with sufficient strength and hardness to achieve a smooth and consistent threadable adjustment as well as having a high degree of structural strength of the threadable engagement. However, these metallic materials are generally heavy in comparison with fiber reinforced spoke materials. Further, if one attempts to incorporate such metallic threads with a fiber reinforced spoke, this is difficult to achieve and adds complexity and cost to the fiber reinforced spoke while also increasing weight.

It is further noted that in a tension spoke wheel 1, the pre-tension of the spokes 3 induce a longitudinal tensile strain and stretch in the corresponding spokes, as well as a circumferential hoop compression strain of the rim 8. There may also be a strain of the hub assembly 14, however such strains are commonly quite small in comparison to strain of the spoke 3 and/or rim 8. In order for the wheel 1 to effectively support cycling loads, it is important to carefully balance this spoke pre-tension so that the cycling loads are evenly distributed throughout the wheel 1 and so that the wheel rim 8 rotates round and true. It is usually preferable that these strains be within the elastic limit of the corresponding spoke 3 and/or rim 8. This is commonly achieved by adjusting the length of the spoke span to induce strain in the wheel and then locking the spoke connections at its first end 4 and second end 6 to fix the length of the spoke span therebetween and maintain the pre-tension in the spokes 3 while the wheel 1 is in its free-state (i.e. prior to loading the wheel in use).

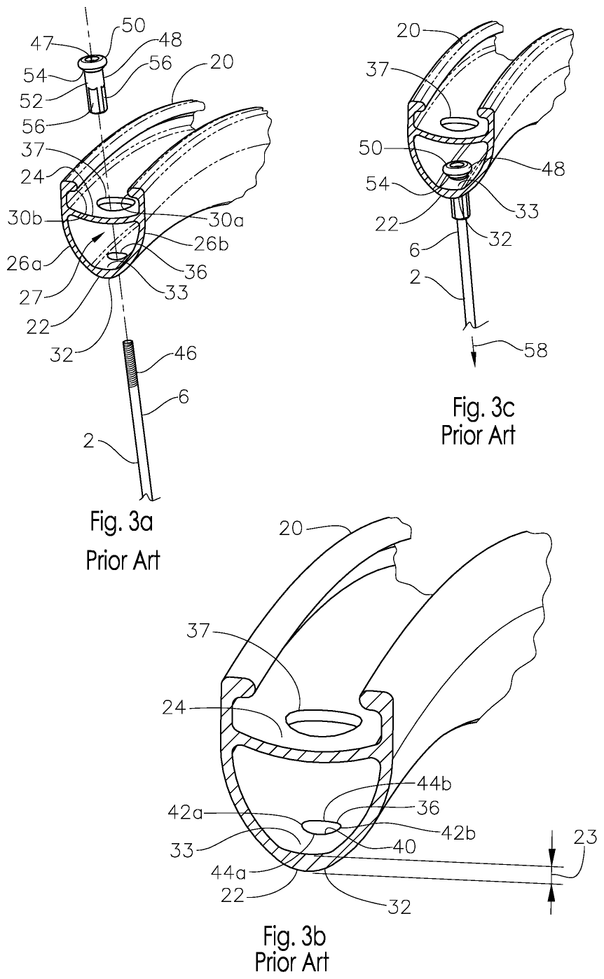

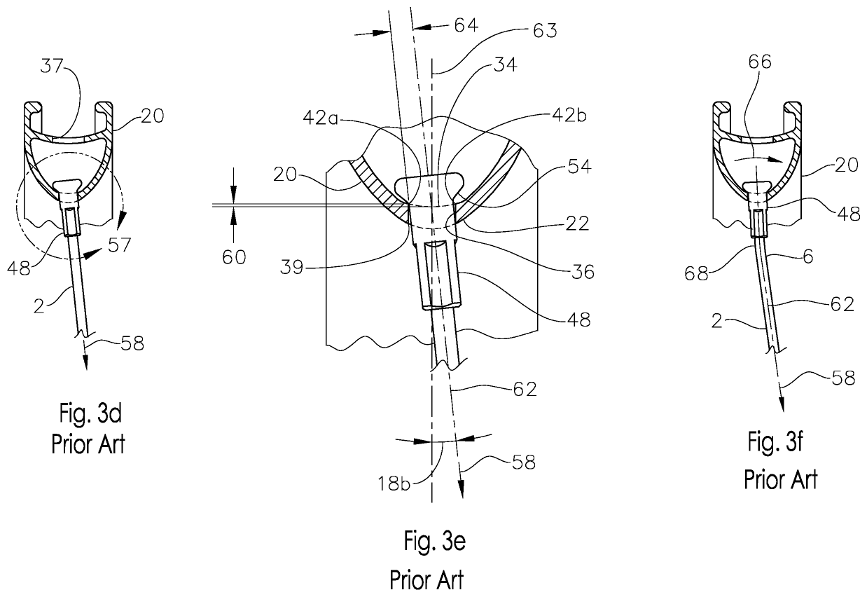

FIGS. 3a-f describe an exemplary rim 20 of generally conventional geometry. As detailed in FIGS. 3a and 3b, rim 20 is of a generally hollow construction, commonly termed “double-wall” construction, and includes a radially inboard spoke bed 22 wall of thickness 23 and a radially outboard tire bed 24 wall and generally radially extending sidewalls 26a and 26b to define a generally hollow circumferential cavity 27. Spoke bed 22 is defined by a radially inboard surface 32 and a radially outboard surface 33. Hooked flanges 30a and 30b are adapted to engage the beads of a conventional tire (not shown).

The spoke bed 22 is pierced with a plurality of spoke holes 36 adapted for connection with their respective spokes 2 via spoke nipples 48. It may be seen that the spoke hole 36 has a radially inboard edge 39 at its intersection with the inboard surface 32 and a radially outboard edge 40 at its intersection with the radially outboard surface 34. Further, outboard edge 40 may be seen to have axially spaced quadrant points 42a and 42b as well as circumferentially spaced quadrant points 44a and 44b. The tire bed 24 is pierced by access hole 37 that is aligned with spoke hole 36, to permit the nipple 48 to be assembled as shown in FIGS. 3a and 3c. Note that access hole 37 is merely one common means to permit the nipple 48 to be assembled to the rim; a wide range of alternative means may be substituted, including means that do not require an access hole.

It is useful to understand that it is common to manufacture the rim 20 by extruding the straight profile shown here and rolling the extrusion into a circumferential hoop with its ends joined by either a welded, sleeved or pinned connection. Spoke holes 36 and access holes 37 are then drilled in their proper locations.

FIG. 3a shows an exploded view that describes the conventional arrangement by which the second end 6 of the spoke 2 is connected to the rim 20. The second end 6 of spoke 2 includes external threads 46 to mate with internal threads 47 of spoke nipple 48. Spoke nipple 48 includes an enlarged head 50 and a shank 52, with a generally conical tapered transition portion 54 extending between the underside of the head 50 and the shank 52. Spoke nipple 48 also includes flats 56 for engagement with a mating wrench (not shown) for manual manipulation to adjust the spoke pre-tension by adjusting the threaded engagement between external threads 46 and internal threads 47. Nipple 48 is considered an “external” spoke nipple, since it has a shank 52 that extends through the spoke hole 36 so that its flats 56 are exposed and may be manipulated externally to the rim 20. A “nipple” or “spoke nipple” is defined herein as an element that is connected to the spoke and that includes a bearing surface for overlie engagement with the rim. Most commonly, the nipple is connected to the spoke by a threadable engagement. An “external nipple”, such as spoke nipple 48, is defined herein as a spoke nipple that extends to a point longitudinally inwardly of the inboard surface of the spoke bed. FIGS. 3c-f shows the spoke nipple 48 threadably assembled to the spoke 2 such that the transition portion 54 overlies and contacts the outboard edge 40. The transition portion 54 serves as a bearing surface or engagement surface of the spoke 2 for bearing interface with the rim 20 to support spoke tension 58 forces. The spoke nipple 48 is thereby braced against the spoke bed 22 to resist the spoke tension 58 of the spoke 2.

It may be seen that the outboard surface 34 of the spoke bed 22 is of generally concave geometry as viewed in the cross-sectional views of FIGS. 3d-f. Thus, the intersection between the cylindrical spoke hole 36 and the concave outboard surface 34 creates a saddle-shaped outboard edge 40, such that quadrant points 42a and 42b are spaced by radial distance 60 to be radially outboard of quadrant points 44a and 44b. With spoke nipple 48 aligned with angle of inclination 18b as shown, it may be seen that the transition portion 54 contacts the outboard surface 34 of the spoke bed 22 only at the quadrant point 42a, which is offset from the longitudinal axis 62 by distance 64. Shank 52 also contacts inboard edge 38, which restrains axial movement of the nipple 48 and forces the transition portion 54 against quadrant point 42a. With the transition portion 54 supported only by quadrant portion 42a, it may be seen that the transition portion 54 does not contact, and is spaced from, the outboard edge 40 at quadrant points 42b, 44a and 44b.

Since the spoke tension 58 acts along the longitudinal axis 62, the offset distance 64 (between the longitudinal axis 62 and contacting quadrant point 42a) tends to induce a bending moment to rotate the spoke nipple 48 in the direction 66 toward a reduced angle of inclination 18b that is no longer in alignment with the spoke centerline 62 or longitudinal axis 62. Further, the spoke tension 58 tends to induce the conical transition portion 54 to ramp against its contact point at quadrant point 42a. This, in combination with the contact between the inboard edge 39 and shank 52 at contact point 45 further induces the nipple 48 to pivot in the direction 66. The result is that the spoke 2 tends to bend in response to the aforementioned moment, thus creating a bent region 68 (FIG. 3f) just inboard of the spoke nipple 48 and thereby inducing a bending stress in the spoke 2. As with all tension-spoke wheels, as the loaded wheel 1 is rotated along the ground, each successive spoke undergoes a cycle of reduced and increased spoke tension 58. This causes the bent region 68 to flex with each revolution of the wheel, creating a much higher potential for fatigue failure of the spoke 2 as compared to a spoke without a bent region 68 and its associated bending stress. Further, the bending and associated flex described here tends to reduce the effective tensile stiffness of the spoke 2 between its attachment points, thereby reducing the overall structural stiffness of the wheel 1.

Additionally, since the majority of the spoke tension 58 is braced and resisted by the overlie engagement between the nipple 48 and only the single contact point at quadrant point 42a, the contact load due to spoke tension 58 induces a very highly concentrated contact stress at this singular contact point. This high contact stress may result in localized galling as the nipple 48 is rotatably manipulated with in its spoke hole 36. Furthermore, this high contact stress may cause excessive stress and deformation of the nipple 48 and/or spoke hole 36. This very high localized stress also commonly causes cracking and failure of the rim due to fatigue. To resist the stress and minimize such failure, the spoke bed 22 needs to be very thick, which adds weight to the rim, detracting from the performance of the wheel.

It is noted that the concentrated single contact point at quadrant point 42a is also coincident with the edge of the spoke hole 36. Thus, not only does the existence of spoke hole 36 create a stress riser in the spoke bed 22, but the region of highest contact stress occurs right on the edge of this spoke hole to amplify this stress riser. As a result, due to high usage and fatigue loading, it is very common for cracks to form in the spoke bed 22 that radiate out from the spoke hole.

It is noted that some have attempted to mitigate this elevated stress by drilling the spoke holes 36 at an angle from the radial axis 29 that is intended to correspond to the longitudinal axis 62 in a procedure known as “angled spoke drilling”. However, this angled spoke drilling does not appreciably increase the contact area of engagement between the transition surface 54 and the outboard edge 40. Correspondingly, the contact stress at this interface remains very high. It would therefore be beneficial to mitigate these fatigue cracks is to modify the conventional design to distribute the spoke contact loads over a larger area of the rim to reduce the contact stress.

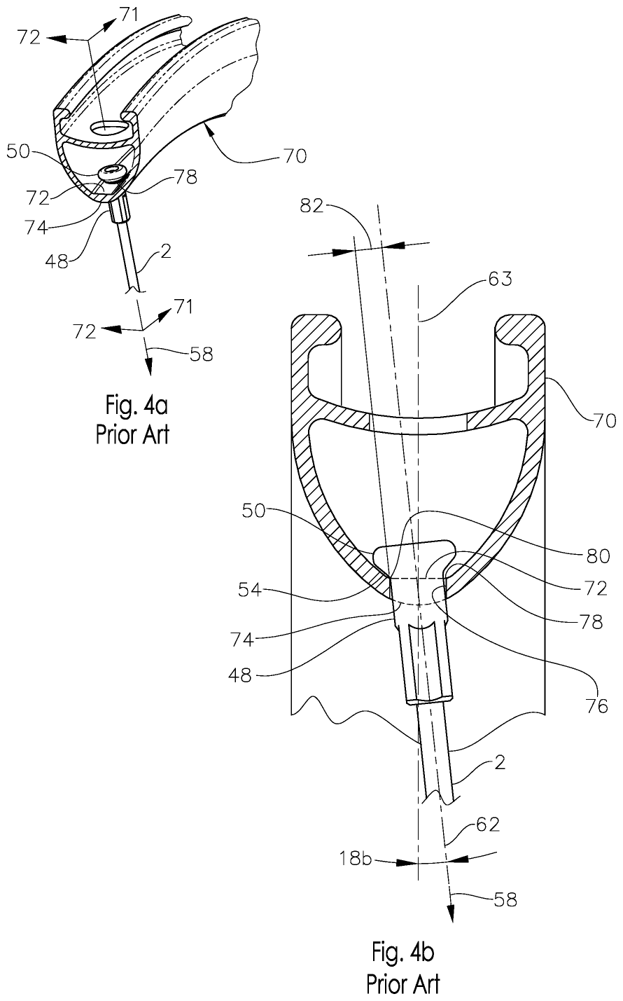

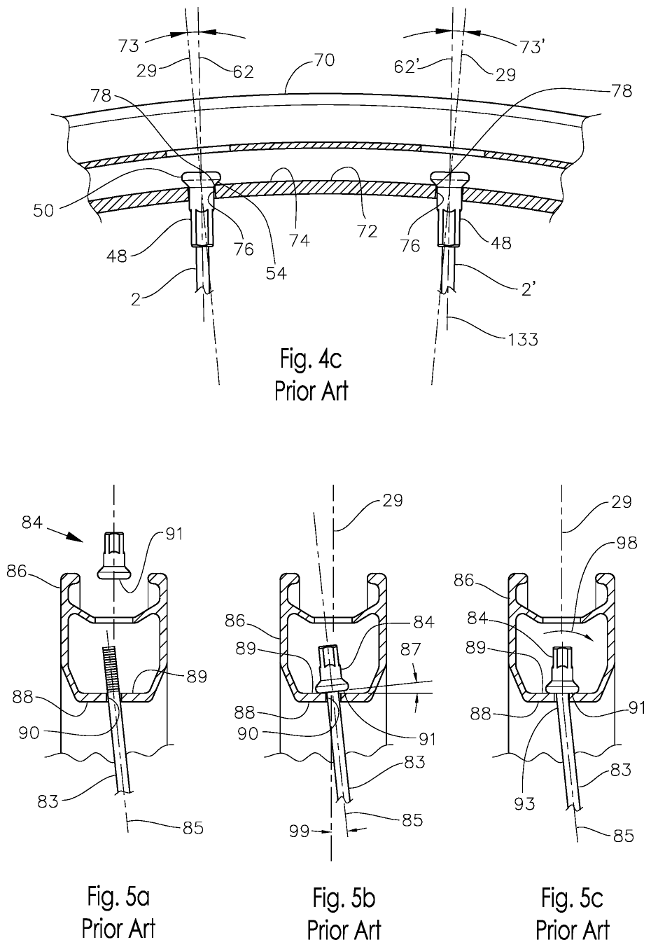

FIGS. 4a-c describe another exemplary rim 70 of conventional geometry. Rim 70 is generally identical to rim 20, however the outboard surface 72 of spoke bed 74 instead has a generally flat contour defining a generally flat cylindrical surface. This means that outboard edge 78 of spoke hole 76 is a flat circular edge. However, due to the angle of inclination 18b of the spoke 2 and spoke nipple 48, the transition portion 54 contacts the outboard edge 78 at only a single contact point 80, which is offset from the longitudinal axis 62 by offset distance 82. The angle of inclination 18b may also be considered to be an axial skew angle of the longitudinal axis 62 relative to the radial axis 29. Like the prior art embodiment of FIGS. 3a-f, this offset distance 82 induces a bending moment in the spoke 2, including the associated bending and flex previously described herein.

Thus, it may be seen that it is advantageous to reduce or eliminate the offset distance 64 or 82 to minimize the bending or flex associated with the prior-art arrangements described in FIGS. 3a-f and FIGS. 4a-b. The following embodiments of the present invention describe a variety of methods to reduce or eliminate this offset distance.

As illustrated in FIG. 2a, spokes are commonly laced such that their longitudinal axis 36 is radially offset from the axial axis 28 such that the spokes cross past each other. This well understood in industry and where the term “cross” is commonly used to describe how many spokes an individual spoke crosses within its span. This radial offset means that the spoke is commonly circumferentially skewed from a radial axis 29 at its intersection with the rim. This is particularly illustrated in FIG. 4c, where longitudinal axis 62 (also considered the “longitudinal axis”) of spoke 2 is skewed from the radial axis 29 by a circumferential clockwise skew angle 73 and longitudinal axis 62′ (also considered the “longitudinal axis”) of spoke 2′ is skewed from the radial axis 29 by a circumferential counterclockwise skew angle 73′.

In contrast to FIGS. 4a-c, which show the nipple 48 as extending through the spoke hole 76 to extend inboard of the spoke bed 74, FIGS. 5a-c describe an arrangement that utilizes a nipple 84 that is entirely radially outboard of the spoke bed 89. Rim 86 is similar to rim 70, with the exception that its spoke hole 90 is sized to provide clearance for only the spoke 83. The rim 86 includes a spoke bed 88 with a radially outwardly facing outboard surface 89. Spoke 83 is similar to spoke 2 and is of conventional configuration, including longitudinal axis 85 and external threads. The nipple 84 includes an engagement face 91 to bear against the outboard surface 89 of spoke bed 88 and internal threads (obscured). Such a nipple 84 is conventional and known in industry as a “hidden” or “internal” nipple.

An “internal nipple”, such as spoke nipple 84, is defined herein as a spoke nipple that is entirely longitudinally outboard of the inboard surface of the spoke bed. Most commonly, an internal nipple extends longitudinally outboard of the engagement surface or bearing surface of the nipple. FIG. 5a shows the nipple 84 prior to its threadable assembly with the spoke 83.

FIG. 5b shows the nipple 84 as next threadably assembled to the spoke 83 in the conventional manner until its engagement face 91 first contacts the outboard surface 89 as shown in FIG. 5b. Due to the bracing angle 99 of the spoke 83, the engagement face 91 does not mate squarely with the outboard face 89, but instead is tilted or canted by angle 87. Further threadable tightening of the nipple 84, and the resulting spoke tension, causes the nipple 84 to rotate in direction 98 so that engagement face 91 bears squarely against the outboard surface 89 as shown in FIG. 5c. However, this rotation results in a kink or bend 93 in the spoke 83, resulting in increased stress and misalignment of the spoke 83, as also described in FIG. 3f. These figures illustrate the particular problems associated with the use of internal nipples with conventional rims.

It is an object of the present invention to increase the contact area and improve the alignment between the transition portion 54 and the spoke hole 76 and/or between the engagement face 91 and the outboard surface 89. This will serve to reduce the contact stress therebetween and result in increased fatigue resistance of the rim and spoke and also greater overall stiffness of the wheel 1. This may be achieved by modifying the spoke bed 74 such that the outboard edge 78 and/or the portion of the outboard surface 72 surrounding the spoke hole 76 is more closely matched to the transition portion 54. For the purposes of definition herein, the outboard edge 78 and/or the portion of the outboard surface 72 that provides blocking contact with a mating surface of the spoke, such as the transition surface 54, is termed the “bearing surface”, since this is the surface and/or edge that bears against the spoke nipple 48 to provide connection between the spoke 2 and the rim 70.

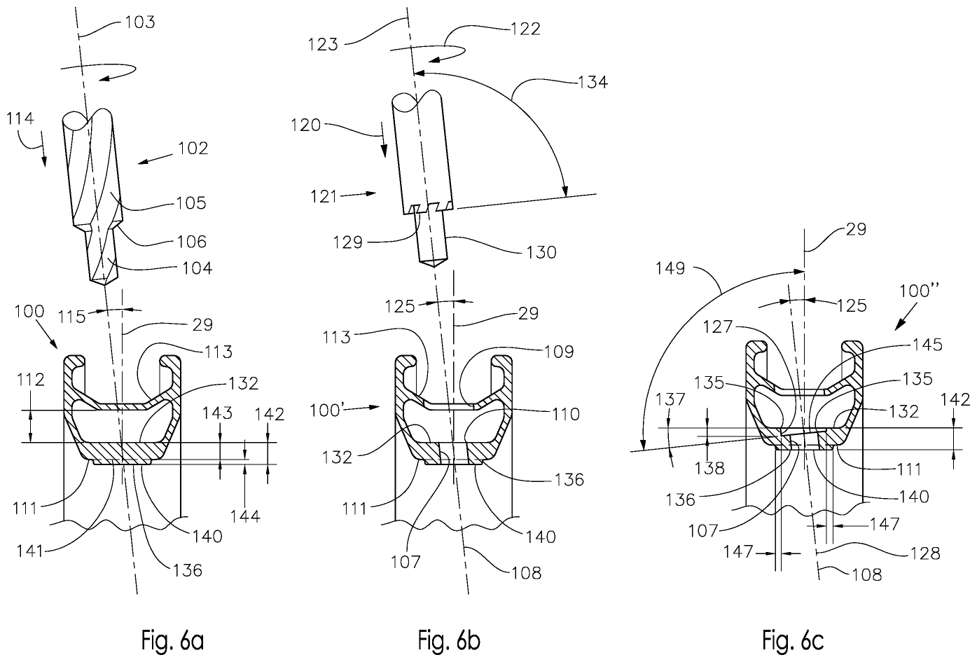

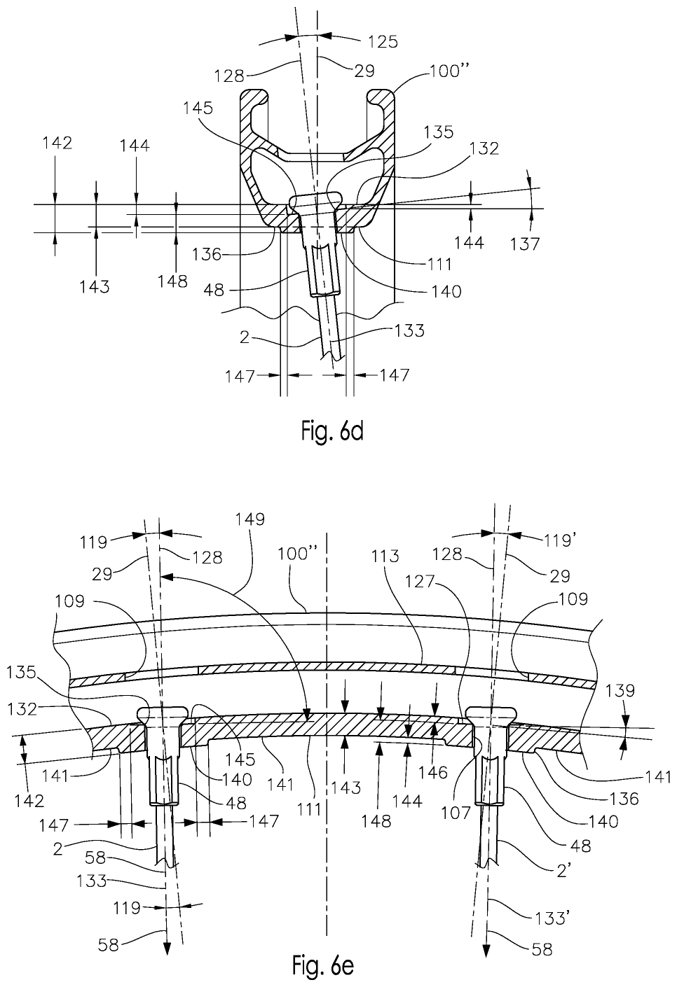

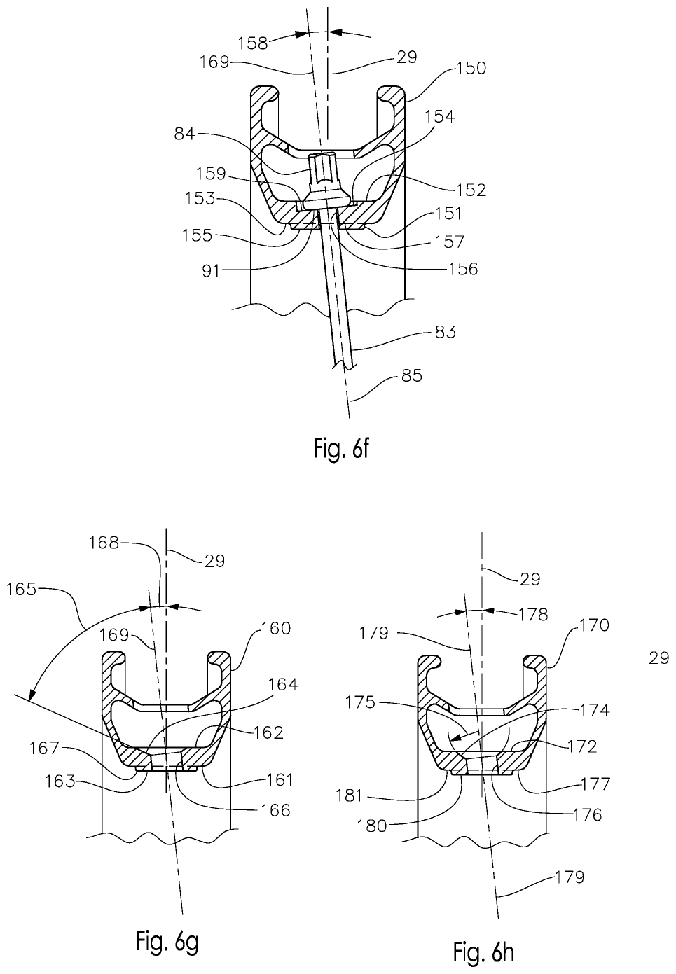

One method for such modification of the spoke bed 74 is to remove material of the spoke bed 74 such that the outboard edge 78 and/or the portion of the outboard surface 72 surrounding the spoke hole 76 is more closely matched to the transition portion 54. An example of such a method is described in FIGS. 6a-e. As shown in FIG. 6a-e, the rim 100 is formed such that spoke bed 111 includes a generally smooth circumferential outboard surface 132 of constant radius and a radially variable inboard surface 136 to provide radially inwardly thickened regions 140 surrounding the locations associated with spoke holes 107, and a radially outwardly thinned region 141 (shown in FIG. 6e) circumferentially positioned between adjacent thickened regions 140. This results in a spoke bed 111 of variable thickness where thickened regions 140 have a thickness 142 greater than the thickness 143 of thinned region 141, including a step dimension 144 therebetween. The thickened regions 140 provide structural reinforcement of the spoke bed 111 in the highly stressed region for connection with the mating spokes and the thinned regions 141 served to minimize the material of the spoke bed 111 for weight savings and reduction of material cost where stresses may be lower. Rim 100 is of double-wall construction and includes a tire bed wall 113, a spoke bed wall 111, and a radial gap 112 therebetween. The rim 100 may be bladder-molded of reinforced composite material or other materials and processes known in industry.

The rim 100 is first shown in FIG. 6a where its spoke bed 111 wall is initially formed without any spoke holes or recesses. A step drill 102 is shown in FIG. 6a to be aligned prior to drilling the spoke hole in the rim 100. A step drill 102 is of a configuration known in industry and includes a cutting surface with a small-diameter portion 104 for piercing the spoke hole 107 through the spoke bed 111, a large diameter portion 105 for piercing the spoke access hole 109 through the tire bed wall 113, and a transition portion 106 therebetween. This step drill 102 is but one well-known and representative methods for adding a spoke hole 107 to a rim 100. Other methods known in industry may be substituted. The step drill 102 may be aligned such that its drill axis 103 has an axial angle 115 and a circumferential angle (not shown) relative to the radial axis 29 such that the resulting spoke hole 107 will be angled to correspond to the bracing angle and/or the circumferential angle of the spoke. Such angled spoke hole drilling is well known in industry. The step drill 102 is positioned such that the resulting spoke holes 107 are aligned to axially and circumferentially overlap the thickened regions 140. Alternatively, the spoke hole 107 may be drilled in alignment with the radial axis 29 or another angle deemed suitable.

As shown in FIG. 6b, the rim 100 has next been drilled by the step drill 102 in direction 114 in the conventional manner as described hereinabove to pierce both the tire bed wall 113 and the spoke bed wall 111, creating the spoke hole 107 and spoke access hole 109 respectively, with both holes aligned along a hole axis 108. Spoke hole 107 includes a radially outward entrance or outboard edge 110. As shown, a rotary facing tool 121 is aligned such that its rotation axis 123 is preferably collinear with drill axis 103 and has an axial skew angle 125 and a circumferential skew angle 119 relative to the radial axis 29. It is further preferred that rotational axis 123 corresponds to the bracing angle and circumferential angle of a mating spoke (not shown) and is shown here to have a flat and square cutting face 129 and a cylindrical pilot tip 130. Cutting face 129 face is shown to be flat and planar and perpendicular to rotational axis 123.

When the facing tool 121 is rotated in direction 122 about its rotation axis 123 and presented to the outboard surface 132 of the spoke bed 111 in direction 120, it will remove some material of the spoke bed 111 and create a radially inwardly recessed counterbore or spot face 127 of depth 146 therein. The pilot tip 130 may also be piloted within the spoke hole 107 to aid in alignment of the facing tool 121. As shown in FIG. 6c, the facing tool has next formed a recess or spot face 127 of radial recess depth 138 in the outboard surface 132 of the spoke bed 111. The spot face 127 provides a bearing surface 145 that is flat and planar and generally perpendicular to the rotation axis 123.

Since Spot face 127 may be considered to be a revolved surface that is revolved about a revolved axis, such as face axis 128, which is collinear to rotational axis 123 of the cutting face 129. The face axis 128 may be considered as an axis generally perpendicular to the bearing surface 145. Since bearing surface 129 is created with a rotary cutting tool (i.e. facing tool 121), it is considered to be a revolved surface that is revolved about face axis 128, which is shown here to be collinear with rotation axis 123. Additionally, the spot face 127 creates a new outboard edge 135 of the spoke hole 107. This describes a spot-facing machining operation that is well-known in industry. A “revolved surface” herein may be used to describe a surface that is rotationally symmetrical about a revolved axis (i.e. face axis 128) and does not necessarily require that it has been formed with a rotary tool. It may be considered that the outboard surface 132 has thus been modified (as shown in FIG. 6c) to include spot face 127.

It is noted that, corresponding to axial skew angle 125, the bearing surface 129 is inclined, tilted, or canted by axial tilt angle 137 relative to a plane tangent to the outboard surface 132. Correspondingly, the outboard edge 135 of spoke hole 107 is now also tilted by axial tilt angle 137. Thus, whether a mating spoke nipple will bear against the bearing surface 129 or against the outboard edge 135, the both geometries are skewed from the radial axis 29 and aligned to be square or otherwise be more closely matched to the mating bearing surface (i.e. transition surface 54, for example) of the spoke nipple for greater surface contact and reduced misalignment therebetween. For this example, it is preferable that the outboard edge 135 be aligned to be generally matched with the transition surface 54 around the perimeter of the outboard edge 135 to maximize the mating contact therebetween, with a maximum gap therebetween of 0.1 millimeters. This is in contrast to the higher contact stresses and greater misalignment of a conventional outboard surface 72 and outboard edge 78 as illustrated in FIGS. 4a-c and 5a-c. For bicycle wheel applications, it is preferred that the axial skew angle 125 and corresponding axial tilt angle 137 be between 4 degrees and 12 degrees, or more preferably greater than 4 degrees. Also, for bicycle wheel applications with crossed spoke lacing (i.e. not radially laced), it is preferred that the circumferential skew angle 119 and corresponding circumferential tilt angle 139 be between 2 degrees and 10 degrees, or more preferably greater than 3 degrees.

As shown in FIG. 6c, the bearing surface 145 surrounds and circumscribes the spoke hole 107 about the hole axis 108 as is most preferred. However, it is also envisioned that less material is removed during spot facing such that the spot-faced bearing surface only partially circumscribes the spoke hole 107 about hole axis 108, such that some original outboard surface 132 remains adjacent the spoke hole 107. It is preferred that the spot-faced bearing surface circumscribes the spoke hole 107 by at least 180 degrees. The facing tool 121 may also be aligned such that its rotation axis 123 has a circumferential skew angle relative to the radial axis 29 such that the resulting bearing surface 129 will correspondingly be a revolved surface that is perpendicular to the circumferential skew angle 119. As shown here in FIGS. 6a-e, the longitudinal axis 62, the hole axis 108, and the face axis 128 are all collinear as is preferred.

As shown in FIG. 2b, the spoke 2 connected to hub flange 16a has an axial bracing angle 38. It is also understood that the spoke 2 connected to hub flange 16b also has an axial bracing angle in an axially opposed direction. Similarly, it is understood that the rim 100 may include some bearing surfaces 129 that have the axial tilt angle 137 optimized for connection with a spoke 2 that is connected to a first hub flange (such as hub flange 16a of FIG. 2b), and also include other bearing surfaces (not shown) that have a tilt angle axially opposed to tilt angle 137 that are optimized for connection with a spoke 2 that is connected to a second hub flange (such as hub flange 16b of FIG. 2b).

The process described in FIGS. 6a-c is a 2-step process, including a drilling process using step drill 102 and a spot-face process using facing tool 121. Alternatively, the drilled spoke hole 107 and the spot-faced bearing surface 129 may be achieved in a single operation or process. For example, the transition portion 106 of step drill 102 may be configured to provide a square cutting surface like the cutting face 129 of the facing tool. By carefully controlling its depth-of-cut in the drilling process, this transition surface may be utilized to cut into the outboard surface 132 to create the bearing surface 129. As a further alternative, the transition surface 106 and/or the cutting face 129 may be shaped to any desired profile to create a correspondingly profiled bearing surface. Examples of such alternatively profiled bearing surfaces are described in FIGS. 6g and 6h. As a still further alternative, the bearing surface 129 may be formed prior to the forming of the spoke hole 107, where the spoke hole 107 may be formed by piercing through the bearing surface 129.

It is noted that some material is removed from the spoke bed 111 by spot face 127 reducing the spoke bed thickness 142 in this region to thickness 148. For this reason, it is very advantageous to position the spot face 127 within the thickened region 140 to provide sufficient structural thickness and support to compensate for this removal of material. This thickened region 140 serves to provide additional thickness 142 (as compared to the thinned region 141) to ensure that the material removal associated with spot face 127 leaves sufficient thickness 148 and does not adversely weaken the spoke bed 111 in this highly stressed region surrounding the spoke 2. The step dimension 144 may be less than or equal to depth 146 or it may be greater than depth 146 as may be preferred to provide additional structural reinforcement at this highly stresses region surrounding the spoke hole 107. Further, it is preferable to provide a lateral margin 147 between the thickened region 140 and the spot face 127 to ensure that sufficient structural thickness of spoke bed 111 material surrounds the contour of the spot face 127. It may be preferable that lateral margin 147 be equal to or greater than 1 millimeter or more preferably equal or greater than thickness 148. It is noted that the spot face 127 extends laterally outwardly of the spoke hole 107 and the thickened region 140 extends laterally outwardly of the spot face 127.

FIG. 6d shows the spoke 2 and nipple 48 as next assembled to the rim 100 in the conventional manner. Spoke 2 and nipple 48 are identical to those described in FIGS. 4a-c. The transition surface 54 is shown to squarely contact the outboard edge 135 for a full circular perimeter of contact therebetween. Thus, the outboard edge 135 provides a bearing surface or edge to create a blocking engagement with the nipple 48 and to support spoke tension 58 forces. As such, the outboard edge 135 (in addition to bearing face 145) may also be considered a bearing surface, especially since outboard edge 135 provides blocking engagement with the nipple 48 to support spoke tension forces 58. This is a significant improvement over the single point of contact described in FIGS. 4a-c and serves to reduce bearing stress between the nipple 48 and the rim 100. It is noted that bearing surface 145 and/or outboard edge 135 provide for an abutting and blocking overlie engagement with the mating spoke 2 (and nipple 48).

As described in FIG. 4c, spokes 2 are commonly laced with a radial offset such that they are circumferentially skewed from a radial axis by angle 73 at its intersection with the rim 100. This is particularly illustrated in FIG. 6e, where spoke centerline 133 (also considered the “longitudinal axis”) of spoke 2 is circumferentially skewed from the radial axis 29 by a clockwise circumferential skew angle 119, while spoke centerline 133′ (also considered the “longitudinal axis”) of spoke 2′ is circumferentially skewed from the radial axis by a counterclockwise circumferential skew angle 119′. It is preferred that the spoke centerline 133 and 133′ extend along the span portion of the respective spokes 2 and 2′. During the drilling and spot facing operations described in FIGS. 6b-c, the drill axis 103 and rotation axis 123 were skewed in a compound angle to also include circumferential skew angles 119 and 119′ (in addition to axial skew angles 125) such that bearing surface 129 is tilted by axial tilt angle 137 in the axial direction and by circumferential tilt angle 139 in the circumferential direction. Correspondingly, the outboard edge 135 of spoke hole 107 is now also tilted by both axial tilt angle 137 and circumferential tilt angle 139. Bearing surface 129 and outboard edge 135 are preferably as close to being perpendicular to the spoke centerline 133 as possible, preferably within 3 degrees of each other. This perpendicularity results in the transition surface 54 squarely contacting the outboard edge 135 for a full circular perimeter of contact therebetween. This is a significant improvement over the single point of contact described in FIGS. 4a-c. While this perfect perpendicularity may not always be feasible, it is understood that the skewed bearing surface 129 results in an improved interface with the spoke nipple 48 in comparison with the prior art designs shown that do not have a skewed bearing surface.

It is understood that, as the nipple 48 is threadably tightened during assembly, the transition surface 54 bears against the outboard edge 135, causing the two surfaces to abrade each other and to deform each other slightly. As a result, the sharp edge of outboard edge 135 is softened somewhat to create a lapped and matched surface interface therebetween.

FIG. 6f describes an arrangement similar to the embodiment of FIGS. 6a-e, where the rim 150 has been cut or machined to remove some material from its outboard surface 152 to create a recess 159 or spot face having a tilted bearing surface 154 that is perpendicular to face axis 169. Rim 150 is similar to rim 100 of FIGS. 6c-e, with the exception that spoke hole 156 is smaller in diameter to provide clearance only for the spoke 83. Like the rim 100, rim 150 is initially formed such that spoke bed 153 includes a generally smooth circumferential outboard surface 152 of constant radius and a radially variable inboard surface 151 to provide localized thickened regions 155 surrounding the locations associated with spoke holes 156 and a thinned region 157 circumferentially positioned between adjacent thickened regions 155. Spoke holes 156 and spot faces 159 are formed in the outboard surface 152 of the spoke bed 153. Spoke 83 and nipple 84 are identical to those described in FIGS. 5a-c, with nipple 84 being configured as an internal nipple as defined hereinabove.

FIG. 6f shows the spoke 83 and nipple 84 as assembled to the rim 150. The bearing surface 154 is tilted to compensate for the axial skew angle 158 of the longitudinal axis 85 of the spoke 83. Also, in a manner similar to that described in FIG. 6e, the bearing surface 154 is preferably circumferentially tilted to compensate for any circumferential skew angle(s) (not shown) of the longitudinal axis 85. As such, the engagement face 91 is shown to squarely contact the bearing surface 154 for a full circular face contact (about longitudinal axis 85) therebetween. In contrast to FIG. 5c, this provides a generous surface-to-surface contact therebetween without inducing increased stress and misalignment of the spoke 83. Spot face 159 may be considered a revolved surface about face axis 169 that is shown here to be collinear with longitudinal axis 85.

FIG. 6b shows a facing tool 121 with a flat planar cutting face 129 that is perpendicular to the rotation axis 123. This produces the revolved flat planar bearing surface 129 shown in FIG. 6c that is recessed from the outboard face 132. Alternatively, an alternate facing tool (not shown) or other means may be employed to provide a concave conical bearing surface 164 that is revolved and rotationally swept to be conical about a face axis 169. The face axis 169 is skewed from the radial axis 29 by axial skew angle 168, which may also include a circumferentially skewed orientation as described hereinabove. In contrast to the flat bearing surfaces 145 and 154 of FIGS. 6a-e and 6f respectively, face axis 169 is not strictly perpendicular to the bearing surface, but may be considered a revolved axis about which the concave conical bearing surface 164 is generated. As shown in the rim 160 of FIG. 6g, the outboard surface 162 of the spoke bed 161 includes a localized concave conical bearing surface 164 (having a conical angle 165) surrounding the spoke hole 166. The conical angle 165 may be matched to the conical transition surface of a mating spoke nipple (not shown) such as the transition surface 54 of nipple 48 shown in FIG. 4b. This provides a generous surface-to-surface contact between transition surface 54 and bearing surface 164 without inducing increased stress and misalignment of a spoke assembled thereto. In a manner similar to rim 100, rim 160 is formed such that spoke bed 161 includes a generally smooth circumferential outboard surface 162 of constant radius and a radially variable inboard surface 163 to provide localized thickened regions 167 surrounding the locations associated with spoke holes 166 and a thinned region circumferentially spaced between adjacent thickened regions.

As a further alternative, an alternate facing tool (not shown) or other means may be employed to provide a semi-spherical concave bearing surface 174 that is rotationally swept and/or revolve about a face axis 179 to provide the semi-spherical concave bearing surface 174 as shown in FIG. 6h. The face axis 179 is shown to be skewed from the radial axis 29 by axial skew angle 178, which may additionally include a circumferentially skewed orientation as described hereinabove. As shown in the rim 170 of FIG. 6h, the outboard surface 172 of the spoke bed 171 includes a localized concave spherical bearing surface 174 surrounding the spoke hole 176. The spherical radius 175 may be matched to a spherical transition surface of a mating spoke nipple (not shown). This provides a generous surface-to-surface contact between the spherical transition surface and bearing surface 174 without inducing increased stress and misalignment of a spoke (not shown) assembled thereto. The spherical ball-and-socket interface between the spherical transition surface and spherical bearing surface 174 may be utilized to provide a swivel therebetween such that the spoke nipple may be self-aligning to accommodate a range of bracing and/or circumferential angles of the spoke. In a manner similar to rim 100, rim 170 is formed such that spoke bed 171 includes a generally smooth circumferential outboard surface 172 of constant radius and a radially variable inboard surface 177 to provide localized thickened regions 180 surrounding the locations associated with spoke holes 176 and a thinned region 181 between adjacent thickened regions 180.

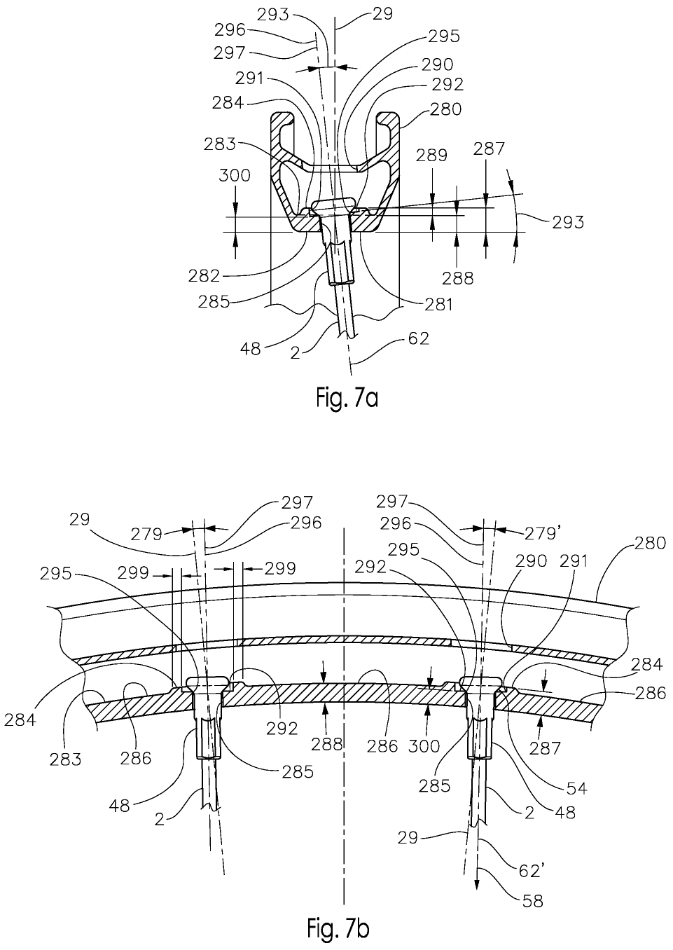

It is envisioned that the rim 100 may be bladder molded out of advanced composite material as is common. In bladder molding, it is generally easier to control the external surface of the part, since it is controlled by hard mold tooling, whereas the interior surface of the part is controlled by the bladder and the part contours are more difficult to control. Since the inboard surface 136 is an external surface and the outboard surface 132 is an interior surface, it is generally preferable to vary the thickness of the spoke bed by employing a radially variable inboard surface 136, as described in FIGS. 6a-h, because it is generally easier to mold and control the contour of the inboard surface. As such, it is preferable to provide a radially variable inboard surface 136 of the rim. Alternatively, it is also possible, but likely more difficult, to provide a radially variable outboard surface of the spoke bed to achieve a spoke bed of variable thickness. Such an alternative arrangement is described in FIGS. 7a-b.

FIGS. 7a-b describe an arrangement similar to that of FIGS. 6d-e, with the exception that rim 280 is formed such that spoke bed 281 includes a generally smooth circumferential inboard surface 282 of constant radius and a radially variable outboard surface 283 to provide thickened regions 284 surrounding the locations associated with spoke holes 285 and a thinned region 286 between adjacent thickened regions 284. This results in a spoke bed 281 of variable thickness where thickened region 284 has a thickness 287 that is greater than the thickness 288 of thinned region 286, including a step dimension 289 therebetween. The rim 280 may be bladder-molded of reinforced composite material or may be formed using other materials and processes known in industry.

The rim 280 includes spoke hole 285 and access hole 290 as described hereinabove. Outboard surface 283 includes a recess or spot face 291 positioned within thickened region 284 that provides a bearing surface 292 that is flat and planar identical to bearing surface 145 of FIGS. 6a-e. It is noted that, corresponding to axial skew angle 293, the bearing surface 292 is inclined, tilted, or canted relative to the axial axis (not shown). Also, corresponding to circumferential skew angle 279, the bearing surfaces 292 and 292′ are inclined, tilted, or canted relative to a plane tangent to the outboard surface 283. The outboard edge of spoke hole 295 is now correspondingly tilted and skewed as well. Thus, whether a spoke nipple will bear against the bearing surface 292 or the outboard edge 295, the both geometries are aligned to be square or otherwise to be more closely matched to the mating bearing surface (for example, transition surface 54) of the spoke nipple for greater surface contact and reduced misalignment therebetween.

As shown in FIGS. 7a-b, the bearing surface 292 surrounds and circumscribes the spoke hole 285 about the hole axis 296 as is most preferred. It is preferred that the spot-faced bearing surface 292 surrounds the spoke hole 285 by at least 180 degrees. As shown here, the longitudinal axis 62, the hole axis 296, and the face axis 297 are all collinear as is preferred. Spoke 2 and nipple 48 are identical to those described in FIGS. 3a-f and are shown in FIGS. 7a-b to be assembled to rim 280 in the conventional manner and as described hereinabove.

Some material is removed from the spoke bed 281 by spot face 291, creating a recess therein and reducing the spoke bed thickness in this region. For this reason, it is very advantageous to position the spot face 291 within the thickened region 284 to provide sufficient structural support to compensate for this removal of material. The step dimension 289 may equal depth 289 or it may be greater than depth 289 as is preferred to provide additional structural reinforcement at this highly stresses region surrounding the spoke hole 285. Further, it is preferable to provide a lateral margin 299 between the thickened region 284 and the spot face 291 to ensure that sufficient structural thickness of spoke bed 281 material surrounds the contour of the spot face 291. It is preferable that lateral margin 299 be equal to or greater than thickness 300 between spot face 291 and inboard surface 282.

FIG. 7a shows the spoke 2 and nipple 48 as assembled to the rim 280. Spoke 2 and nipple 48 are identical to those described in FIGS. 4a-c. The transition surface 54 is shown to squarely contact the outboard edge 295 for a full circular perimeter of contact therebetween. This is a significant improvement over the single point of contact described in FIGS. 4a-c.

As described in FIG. 7b, spokes 2 are commonly cross-laced with a radial offset at the hub such that they are circumferentially skewed from a radial axis at its intersection with the rim 280. This is particularly illustrated in FIG. 7b, where longitudinal axis 62 is skewed from the radial axis 29 by a circumferential clockwise circumferential skew angle 279 and longitudinal axis 62′ is skewed from the radial axis 29 by a circumferential counterclockwise circumferential skew angle 279′.

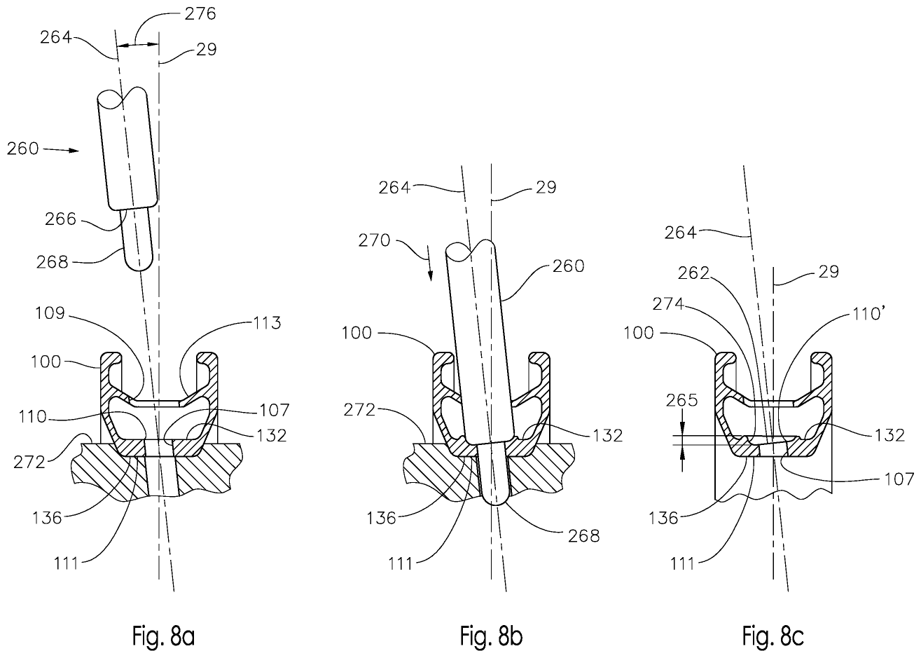

FIGS. 8a-c describe an embodiment similar to FIGS. 6a-e, however instead of utilizing a facing tool 121 that cuts, abrades, or otherwise removes material from the spoke bed 111 to create a skewed bearing surface 145, FIGS. 8a-c utilizes a punch 260 tool to locally coin, forge, or otherwise deform the spoke bed 111 to create a skewed bearing surface 262. Rim 100 is identical to that shown in FIG. 6b, including tire bed wall 113 with access hole 109, and spoke bed wall 111 with outboard surface 132 and inboard surface 136 and with spoke hole 107 therethrough having a radially outboard edge 110. As shown in FIG. 8a, punch tool 260 includes: coining face 266 that is circular about tool axis 264, and pilot pin 268 that is shown to be aligned along a tool axis 264. Punch 260 is in alignment for subsequent coining operation. Tool axis 264 is skewed from the radial axis 29 by skew angle 276. The radially inboard surface 136 of the rim 100 is shown to be temporarily supported in a rigid nest die 272. As shown in FIG. 8b, the coining tool 260 is pressed in direction 270 along tool axis 264 such that pilot pin 268 extends though spoke hole 107 and is piloted therein. Coining tool 260 is further pressed in direction 270 such that coining face 266 impacts and presses against the outboard surface 132 adjacent spoke hole 107, causing the spoke bed 111 to become locally debossed, indented, and deformed to conform to the coining face 266.

As shown in FIG. 8c, with the coining tool 260 and nest die 272 removed, the resulting spoke bed 111 now includes an indent 274 that includes a bearing surface 262 that is aligned relative to the tool axis 264 and is tilted and skewed by skew angle 276, which corresponds to tilt angle 278. Indent 274 is radially inwardly recessed by dimension 265 from the adjacent outboard surface 132. It is noted that outboard edge 110 also becomes distorted and/or displaced in this coining operation to create outboard edge 110′ that is aligned with the bearing surface 262. Bearing surface 262 and outboard edge 110′ are similar in purpose and function to bearing surface 129 and outboard edge 135 respectively as described in FIGS. 6c-e.

The deformation of the spoke bed 111 described in FIG. 8b describes a coining operation known in industry. The nest die 272 is shown here to support the inboard surface 136 so that inboard surface does not become distorted during the coining operation. Alternatively, the nest die 272 may include a recess that will allow the inboard surface 136 to also deform during coining to create a locally bulged region (not shown) of the inboard surface adjacent the spoke hole 107. The preferred material for the spoke bed 111 in such a coining operation is a lightweight metal such as aluminum. An advantage of such a coining operation is that it may serve to locally work-harden the spoke bed, thereby advantageously increasing the strength of the spoke bed 111 in this highly stressed region.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications that are within its spirit and scope as defined by the claims.

What is claimed is:

1. A rim for a vehicle wheel, including:
an axial axis;
a radial axis perpendicular to said axial axis;
a spoke bed wall that includes: an inboard surface facing radially inwardly; an outboard surface facing radially outwardly; and a radial thickness between said inboard surface and said outboard surface;
a spoke hole extending through said spoke bed wall and configured to receive a spoke, wherein said spoke hole includes: an inboard opening at said inboard surface; an outboard opening at said outboard surface; a spoke hole sidewall extending between said inboard opening and said outboard opening; and a spoke hole axis;
wherein at least one of said inboard surface and said outboard surface is radially variable to provide a first radial thickness region laterally surrounding said spoke hole and a second radial thickness region circumferentially offset from said first radial thickness region and of reduced radial thickness relative to said first radial thickness region;
wherein said outboard surface includes a radially inwardly recessed surface adjacent said outboard opening and within said first radial thickness region;
wherein at least a portion of said recessed surface is configured to provide a bearing surface for engagement with said spoke and to support of spoke tension forces.

2. The rim according to claim 1, wherein said inboard surface is radially variable to include a radially inboard portion adjacent said first radial thickness region and a radially outboard portion adjacent second radial thickness region and radially outboard of said inboard portion.

3. The rim according to claim 1, wherein said bearing surface includes a revolved surface that is revolved about a face axis and circumscribes said spoke hole axis by a circumscribing angle greater than 180 degrees.

4. The rim according to claim 3, wherein said face axis is at least one of: (i) axially skewed from said radial axis by an axial skew angle; and (ii) circumferentially skewed from said radial axis by a circumferential skew angle.

5. The rim according to claim 4, wherein said face axis is circumferentially skewed from said radial axis by a circumferential skew angle, wherein said circumferential angle is between two (2) degrees and ten (10) degrees.

6. The rim according to claim 2, wherein said face axis is at least one of: (i) generally parallel to said spoke hole axis; and (ii) generally collinear with said face axis.

7. The rim according to claim 3, wherein said face axis is axially skewed from said radial axis by an axial skew angle and said axial skew angle is at least four degrees.

8. The rim according to claim 1, wherein said outboard surface is axially skewed from said radial axis by an axial skew angle, wherein said axial angle is at least four degrees.

9. The rim according to claim 1, wherein said first radial thickness region extends laterally outward of said recessed surface by a lateral margin and said lateral margin is at least one millimeter.

10. The rim according to claim 3, wherein said bearing surface is a flat planar surface extending perpendicular to said face axis.

11. The rim according to claim 3, wherein said bearing surface fully circumscribes said spoke hole axis by 360 degrees.

12. The rim according to claim 3, wherein said bearing surface is a conical surface that is revolved about said face axis.

13. The rim according to claim 3 wherein said bearing surface is a concave spherical surface that is revolved about said face axis.

14. The rim according to claim 1, including an entrance edge at the intersection between said spoke hole and said bearing surface, wherein said entrance edge is configured to provide a bearing surface for engagement with said vehicle wheel spoke to support spoke tension forces.

15. The rim according to claim 1, wherein: said spoke hole is configured to receive a spoke therein; said spoke includes an engagement surface for blocking engagement with said bearing surface to support spoke tension forces; and said bearing surface is generally matched to said engagement surface.

16. The rim according to claim 15, wherein said engagement surface is in a spoke nipple connected to said spoke and said spoke nipple is an external spoke nipple.

17. The rim according to claim 15, wherein said engagement surface is in a spoke nipple connected to said spoke and said spoke nipple is an internal spoke nipple.

18. A method for producing a vehicle wheel rim, wherein said vehicle wheel rim is a pre-formed element comprising:
an axial axis;
a radial axis perpendicular to said axial axis;
a spoke bed wall that includes: an inboard surface facing radially inwardly; an outboard surface facing radially outwardly; and a radial thickness between said inboard surface and said outboard surface;
wherein at least one of said inboard surface and said outboard surface is radially variable to provide a first radial thickness region laterally surrounding said spoke hole and a second radial thickness region circumferentially offset from said first radial thickness region and of reduced radial thickness relative to said first radial thickness region;
said method comprising the steps of:
(a) initially pre-forming said rim,
(b) subsequently displacing and/or removing material from said spoke bed adjacent said outboard surface to form a radially inwardly recessed surface within said first radial thickness region, wherein at least a portion of said recessed surface is configured to provide a bearing surface for engagement with a vehicle wheel spoke to support spoke tension forces therebetween.

19. The vehicle wheel rim according to claim 18, including a spoke hole extending through said spoke bed wall and configured to receive a spoke, wherein said spoke hole includes: an inboard opening at said inboard surface; an outboard opening at said outboard surface; and a spoke hole axis; wherein said recessed surface is adjacent said outboard opening.

20. The method according to claim 19, wherein said recessed surface is formed subsequent to the forming of said spoke hole.

21. The method according to claim 19, wherein said recessed surface is formed prior to the forming of said spoke hole.

22. The method according to claim 19, wherein said recessed surface is formed simultaneously with the forming of said spoke hole.

23. The method according to claim 18, wherein said recessed surface is formed by a rotary cutting tool that is rotated about a rotary axis to remove material from said spoke bed wall.

24. The method according to claim 18, wherein said recessed surface is formed in a coining operation to displace material of said spoke bed wall.
